(19) United States
(12) Patent Application Publication
(10) Pub. No.: US 2026/0028970 A1
(43) Pub. Date: Jan. 29, 2026

(54) CONTROL PLATE FOR A HYDRAULIC MACHINE

(71) Applicant: Danfoss A/S, Nordborg (DK)

(72) Inventors: Stig Kildegaard Andersen, Krusaa (DK); Georg Herborg Enevoldsen, Nordborg (DK); Tommi Kolb, Nordborg (DK)

(21) Appl. No.: 19/215,666

(22) Filed: May 22, 2025

(30) Foreign Application Priority Data
May 27, 2024 (EP) 24178207.7

(51) Int. Cl. F04B 1/188; F04B 1/2078

(52) U.S. Cl. CPC F04B 1/188; F04B 1/2078; F05C 2225/12

(57) ABSTRACT

The present disclosure relates to a control plate (18) configured to equip a hydraulic machine (e.g. an axial piston machine or a pressure exchanger) for a hydraulic fluid, wherein the control plate (18) includes a body (21) having an arrangement of passage openings (22, 23) for the passage of the hydraulic fluid and a contact face, wherein a whole thickness of the body (21) is formed of a main material, wherein the main material is a first polymer material. The objective of the present disclosure is to provide a control plate (18) having a good lifetime. This objective is solved by a control plate (18), wherein the body (21) includes at least one distinct section which is made of a second polymer material (31), wherein the second polymer material (31) is different from the main material.

### CROSS-REFERENCE TO RELATED APPLICATION

This application claims foreign priority benefits under 35 U.S.C. § 119 to European Patent Application No. 24178207.7 filed on May 27, 2024, the content of which is hereby incorporated by reference in its entirety.

### TECHNICAL FIELD

The present invention relates to a control plate, which is configured to equip a hydraulic machine (e.g. an axial piston machine or a pressure exchanger), wherein the control plate comprises a body having an arrangement of passage openings for the passage of the hydraulic fluid and a contact face, wherein (a whole thickness of) the body is formed of a first (e.g. polymer) material.

Further, the invention relates to a hydraulic machine and to a manufacturing method of the control plate.

### BACKGROUND

In a hydraulic machine of the rotary type, a control plate is used as a port plate or as a valve plate.

For example, a hydraulic machine comprises could be in the form of an axial piston machine which a cylinder drum which is rotatably arranged in a housing and comprises a number of cylinders. The cylinders are in fluid connection with a supply of pressurized hydraulic fluid, when the hydraulic machine is used as a motor, whereas the other cylinders are in connection with a return line. The control plate comprises an arrangement of passage openings, e.g. having at least two kidney shaped passage openings one of which is connected to a pressurized hydraulic fluid supply and the other is connected to the return line.

### SUMMARY

The invention is, for example, applicable for hydraulic machines used as pumps as well.

Mostly, oil is used as a hydraulic fluid. Oil has lubricating characteristics. In other cases, the hydraulic fluid is formed of water. Regardless of the hydraulic fluid, in operation of the hydraulic machine, cavitation of fluid may occur and the cavitation can damage the control plate, especially surfaces of the control plate. As soon as the surface erosion caused by cavitation are too severe, the control plate needs to be replaced.

The object underlying the invention is to provide a control plate which has a good lifetime.

This objective is solved by a control plate according to claim 1.

The body is formed of a first material. The first material of the body may be a first polymer material. The body comprises at least one (distinct) section, which is made of a second material (e.g. a second polymer material), wherein the second material is different from the first material (e.g. the first polymer material). The body may comprise several (i.e. at least two) distinct sections formed of the second polymer material.

Apart from the section(s) formed of the second (polymer) material, the whole body of control plate may be formed of the first (polymer) material. Especially, a whole thickness of the body may be formed of the first polymer material (where no distinct section is located). The second (polymer) material is arranged in the distinct sections(s).

According to one aspect, the distinct section(s) may be arranged where damages due to cavitation are typically observed, especially if the first (polymer) material is used there instead of the second (polymer) material.

Different kinds of materials have different characteristics. For example, the first material (the first polymer material) can comprise good friction characteristics and/or good structural characteristics (like strength, especially with regard to its specific weight). the second material (e.g. the second polymer material) can exhibit good cavitation damage resilience properties.

Especially, the cavitation damage resilience properties of the second material (e.g. the second polymer material) can be higher than those of the first material (the first polymer material). As a result, each part of the control plate can be optimized according to the actual load within certain sections, e.g. friction, cavitation, abrasion, etc.

According to one aspect, the control plate may be adapted for engaging a counterpart of the hydraulic machine, e.g. a pressure plate of the hydraulic machine. In more detail, the contact face may be adapted for engaging the counterpart of the hydraulic machine. The contact face may be configured for sliding abutment onto the counterpart during operation. Said abutment may be in an at least substantially sealing manner.

The control plate may be adapted to form part of a hydraulic machine with rotating elements. For example, the control plate can be a port plate/valve plate for a hydraulic machine with rotating elements.

The counterpart can be, for example, a pressure plate and/or a cylinder drum of the hydraulic machine.

The contact face may be arranged (at least substantially) perpendicular to axial direction of the control plate. The axial direction may be parallel to (or even coincide with) an axis of relative rotation between the control plate and the counter-part.

The contact face may be one end side of the control plate along the axial direction of the control plate.

The control plate may have a disc-shaped basic form.

For example, the first material (the first polymer material) can have good friction properties in combination with its counterpart. For example, the counterpart can be formed of stainless steel and/or ceramics. The second (polymer) material can be provided within the distinct section(s) of the body at locations which are vulnerable to cavitation, such that wear/damage resulting from cavitation is kept low. Further, for example, a third polymer material can be provided in another area, which might be prone to abrasion via particles, wherein the third material is sturdy to such an abrasion. This allows a good lifetime of the control plate.

According to one aspect, one of, several of, or all of the passage openings can be annular and/or kidney-shaped. This allows good control of fluid flow between the passage opening and the counterpart. In operation, the counterpart may rotate relative to the control plate, sliding against the contact face. Fluid openings arranged in the counterpart (especially in an engagement face engaging the contact face of the control part) may be in intermittent fluid contact to the passage opening of the control plate due to the relative rotations.

In one embodiment, the at least one distinct section extends at least partially at a surface of the control plate. Especially, the at least one distinct section may extend at least partially at the surface of the control plate at the contact face. The contact face is particularly prone to be damaged by cavitation. Naturally, all distinct sections can extend at a least partially at the surface of the control plate, especially at the contact face.

In an embodiment of the invention, the first polymer material is fiber reinforced polymer. This material can be, for example, carbon fiber reinforced polymer, especially a carbon fiber woven composite material. Such a material has a good strength, so that the hydraulic machine equipped with such a control plate can be operated with high hydraulic pressures.

In an embodiment of the invention, the control plate comprises a circular sliding track (briefly referred to as the sliding track) at the contact face, wherein at least one of the passage openings is arranged in the sliding track, wherein the second (polymer) material is arranged within the circular sliding track. In other words, the at least one distinct section is arranged in the sliding track. In this case, the (at least one) distinct section, in which the second (polymer) material is provided, is arranged within the circular sliding track. In operation, parts of the circular sliding track can be subjected to cavitation. Especially these parts can be equipped with the second (polymer) material, which is able to withstand cavitation better than the first (polymer) material. A good lifetime of the control plate is archived.

One of, several of, or all of the passage openings may be arranged in the sliding track.

The passage openings may open at the contact face. For example, each passage opening may have at least one first open end at the contact face (especially in the sliding track) and at least one second open end at a location distanced from the contact face, e.g. at an end face of the control plate opposite to the con-tact face in the axial direction.

In an embodiment of the invention, the contact face comprises the circular sliding track and the surface of the contact face is smoother in the sliding track than in a region of the contact face outside the sliding track. In this case, not the whole contact face but only the (distinct) sliding track might be used for contact with the counterpart. If the sliding track is particularly smooth, friction and hence wear can be reduced.

The circular sliding track may extend along a circular direction (e.g. with regard to the disc-shape of the control plate, the axial direction, and/or about the axis of relative rotation).

In an embodiment of the invention, the second (polymer) material is arranged at least (respectively) between adjacent passage openings along the circular direction, e.g. at the contact surface. For example, the second (polymer) material can be arranged at least between end zones of the passage openings, e.g. the kidney-shaped (passage) openings, respectively. End zones of the passage openings refer to the ends of the passage openings which are closest to each other, e.g. along the circular direction. As described above, in operation, one of the passage openings may be subjected to the high pressure supply, wherein the other passage opening may be in fluid connection with the return line. This results in a high pressure difference between the two passage openings. By providing the second (polymer) material between the end zones of the passage openings, the second material is provided within areas highly subjected to cavitation. The second (polymer) material has better cavitation handling characteristics than the first (polymer) material, such that the second (polymer) material can withstand cavitation in a good manner extending the lifetime of the control plate.

In an embodiment of the invention, the circular sliding track is raised in relation to surfaces adjacent to the circular sliding track (i.e. for example compared to the rest of the contact face). At least one of the passage openings can be arranged within the raised circular sliding track. By raising the circular sliding track in relation the adjacent surfaces, a high surface pressure can be applied to the circular sliding track, providing a good sealing in combination with counterpart of the hydraulic machine, e.g. with the cylinder drum of the hydraulic machine. This portion is also subjected the most to cavitation and friction. Therefore, by providing the second material within this portion results in a good lifetime. Especially, the raised sliding track may be formed at least in portions along the circular direction where the ends of the passage opening(s) for the high fluid pressure at are located the contact surface.

The circular sliding track may extend completely along the circular direction. However, it is also possible that the sliding track is formed intermittently along the circular direction. For example, the sliding track might be not formed (or at least not raised) along the complete circular direction. The sliding track might be not formed or at least not raised in some portion(s) along the circular direction. For example, the sliding track might be interrupted (not formed) or at least not raised in annular portions where the ends of the passage opening(s) for low fluid pressure are located at the contact surface.

In an embodiment of the invention, the second material is at least partially arranged in a recessed section of the body. For example, this recessed section is of rectangular, annular, or circular shape. By providing the second material in a recessed section, which is recessed relatively to the adjacent surface, the second material is positively fixed to the body. Furthermore, the surfaces of the second (polymer) material and the first (polymer) material can be (at least locally) adapted to each other, such that one continuous, flat surface is created, e.g. at least on the sliding track, where no passage openings are arranged. This results in good friction characteristics and good sealing.

In one embodiment, the recessed portion has at least one undercut so that the second (polymer) material is mechanically locked to the body. This improves reliable fixation of the second (polymer) material to the body.

In an embodiment of the invention, a thickness of the distinct section is more than 0.1 mm and/or less than 3 mm, preferably less than 2 mm, or the section extends through the thickness of the control plate. Said thickness may be measured in a direction that is (at least substantially) parallel to the axis of relative rotation, e.g. along the axial direction. In a first case, wherein the thickness of the section is more than 0.1 mm and less than 3 mm, preferably less than 2 mm, the section of second material forms a layer on the body. In a second case, the second material replaces a part of the first material in a thickness direction of the body. Depending on the characteristics of the hydraulic machine, either case is preferred. The first case is suitable for high pressures, while the second case allows a greater wear. Accordingly, the suitable case can be chosen for the corresponding characteristics.

The second (polymer) material can be a reinforced material. According to one aspect, it might be reinforced with elongated reinforcement particles. The elongated reinforcement particles can include/consist of chopped fibers (e.g. chopped carbon fibers and/or chopped glass fibers), nano-tubes, and/or any kind of short elongated component that modifies the properties of the second material.

In an embodiment of the invention, the second (polymer) material comprises a micro-structured surface.

In case of a fiber reinforced second material, for example, the elongated reinforcement particles (e.g. small chopped carbon fibers) are aligned in a surface layer in a specific orientation, such that the elongated reinforcement particles are aligned in a parallel, helical, annular, circular, or diamond (rhombus) pattern. This leads to good cavitation withstanding characteristics, while minimizing any potential impact to e.g. the low-friction properties of the first material. For example, additive manufacturing can be used for depositing the second (polymer) material in a desired shape. In the present application, additive manufacturing relates to a method which is used to deposit material, e.g. polymer material, in a desired, 2D and/or 3D shape. This includes 3D-printing. This allows for a good flexibility in terms of surface design.

In an embodiment of the invention, the second polymer material is PEEK or PEEK comprising one or more filler material. Filler materials are the elongated reinforcement particles (such as chopped short carbon fibers), ceramic particles etc. just to name some examples. The filler material can be chosen depending on the hydraulic fluid, the friction characteristics etc.

In an embodiment of the invention, the first (polymer) material comprises friction reducing properties. In such a case the hydraulic machine can be used in connection with water as hydraulic fluid.

In an embodiment of the invention, the first (polymer) material is reinforced by fibers having a length of at least 5 mm. The longer the fibers are, the more stable the control plate is. A coat applied to a steel core of the control plate in the prior art is usually produced by injection molding. During injection molding the fibers used for the reinforcement of the polymer material are shortened in an extruder, so that the length of the fibers is usually limited to below 1 mm. Thus, having a fiber length of at least 5 mm gives a considerable strength of the control plate.

In an embodiment of the invention, at least in a thickness region adjacent the contact face more than 50% of the fibers include an angle with the contact face of less than 30°. Thus, the fibers are more or less oriented parallel to the contact face (in other words, the fibers are arranged substantially perpendicular to the axial direction) so that the counter part of the control plate runs basically in parallel to most of the fibers and does not slide over a surface which is roughened by the ends of the fibers. Tribological contacts are thus in an optimum form. The mostly parallel orientation of the fibers in the first (polymer) material means that there is a higher area of said fibers in contact with the counterpart. This will also improve the wear resistance of said control plate.

In an embodiment of the invention, the fibers of the first (polymer) material are arranged in layers. In other words, the fibers are arranged in planes which are arranged substantially parallel to each other and substantially parallel to the contact face. Thus, the fibers reinforce the control plate in a direction parallel to the contact face and thus in the direction in which a higher strength and stiffness is desired. In a direction perpendicular to the contact face, a lower stiffness is of advantage, since in this direction the control plate can show some spring characteristics to dampen noise.

In an embodiment of the invention, the layers of the first (polymer) material and/or second (polymer) material are stacked in a direction perpendicular to the contact face (e.g. in the axial direction). This is a simple way to orient the fibers in the desired way. The direction of the fibers can be different between different layers, for example 0° and 90° or 0° and ±45°. Thus, an anisotropy in the strength and the stiffness can be obtained parallel to the contact face.

In an embodiment of the invention, the first (polymer) material comprises a fiber content of at least 55%. This is a rather high fiber content and allows for a high strength of the control plate.

In an embodiment of the invention, the fibers of the first (polymer) material are made of carbon and/or ceramic fillers, in particular ceramic nano fillers. Such a filler also increases the hardness of plastics. Such fibers or fillers are in particular useful in connection with the use in a hydraulic machine.

In an embodiment of the invention, the first (polymer) material of the body is softer than steel. This is true for most plastic materials.

The objective is solved with a hydraulic machine (e.g. an axial piston machine or a pressure exchanger) comprising a control plate according to any one of the embodiments disclosed. Such a hydraulic machine requires a low maintenance effort since the cavitation related wear of the control plate is low.

The objective is solved by a method to manufacture a control plate for a hydraulic machine as described above. The method comprises the following steps:
a. Providing the body made of a first material (e.g. a first polymer material) with an arrangement of passage openings and a contact face,
b. Depositing a second material (e.g. second polymer material) within at least one distinct section of the body, wherein the second (polymer) material is different from the first (polymer) material.

The embodiments, modifications, and advantages described with respect to the control plate may apply with respect to the method accordingly, and vice versa.

In step A), the body is provided. This body can be formed with a non-additive manufacturing method. The body is formed in its whole thickness of the first material (e.g. the first polymer material). Further, the body is equipped with the second (polymer) material in step B).

According to one aspect, depositing the second (polymer) material can be done by means of additive manufacturing.

Additive manufacturing is a collective term for manufacturing methods in which material is selectively deposited. The newly added material bonds with existing material. This can be done by melting the two materials, by photochemical reaction and/or by an adhesive. In order to produce a 3D element via additive manufacturing, several layers of (polymer) material are deposited on top of each other. The thickness of each layer needs to be customized depending on the material to be processed. A first layer of the second (polymer) material should form a good connection with the first material of the body. Each additional layer of the second material is bonded to the previously laid layer. A desired thickness of the second (polymer) material can be achieved by adding further layers. As a result, additive manufacturing allows a flexible design of the second (polymer) material.

Metal, polymers, and ceramics can be processed by additive manufacturing. In the present application, polymers are used as the second (polymer) material. Polymers can be filled with so called fillers. Such fillers are for example chopped carbon fibers and/or ceramic particles, depending on the desired properties of the polymer.

By using this method, the second (polymer) material can be deposited in specific sections of the body creating a surface withstanding cavitation better than the first (polymer) material.

In one embodiment, the second (polymer) material is prefabricated and bonded and/or mechanically fastened to the first (polymer) material at the desired position.

According to one aspect, the contact face can be provided with a layer of the second (polymer) material, such that the whole body is covered with the second (polymer) material at the contact face. In one embodiment, the whole body can be provided with a layer of the second (polymer) material, such that the whole body of first (polymer) material is covered in the second (polymer) material. The layer of the second (polymer) material might have a varying thickness, such that areas expected to have a high cavitation impact are equipped with a thicker layer of the second (polymer) material than other areas.

In an embodiment of the invention, after step A) and before step B), in step A1) a part of the body is removed to create a recessed section, wherein in step B) the second (polymer) material is deposited into the recessed section. For example, this recessed section is of rectangular, annular, or circular shape. The recessed section has for example a depth of more than 0.1 mm and less than 3 mm, preferably less than 2 mm, or alternatively, the recessed section penetrates the body in its thickness direction to provide a through hole. To remove the part of the body, the body is machined, for example milled, drilled or alike.

Alternatively, the recessed section can already be arranged on the provided body. In this case, the recessed section might be machined to provide a surface characteristic which allows a good bond between the first (polymer) material and the second (polymer) material.

According to one aspect, the method comprises a step for roughening a surface where the second (polymer) material shall be added. Roughening can be formed, for example, by sand-blasting, and/or the like.

In an embodiment of the invention, during step B) a micro-structured surface is created. The micro-structured surface relates to a surface characteristic, in particular its topography and for example a roughness. Furthermore, the microstructure surface relates to the top layer. The top layer may extend up to 0.5 mm, maybe 0.1 mm or even 0.05 mm, below from the outer surface of the second (polymer) material. In this area, fillers like chopped fibers can be arranged according to a predetermined pattern, e.g. parallel, annular, circular, helical, rhombus, diamond, circular arc, etc. For example, fibers arranged within the micro-structured surface are arranged along a direction of movement between the control plate and the cylinder drum. The fiber orientation of the micro-structured surface is produced during depositing the second material. The fibers are laid, oriented according to a movement of a nozzle of the additive manufacturing machine. The filler affects the surface and its properties. This allows a compromise between a good friction characteristics and good anti cavitation characteristics.

In an embodiment of the invention, in step A1) a worn section of the second material is removed. This allows to refurbish worn control plates, which is cost effective and requires little effort. Just steps A1) and the following steps need to be redone to provide a refurbished control plate.

In an embodiment of the invention, after step B), in step C) the deposited second (polymer) material is machined. For example, the second (polymer) material is machined to provide a continuous surface of the second (polymer) material with its neighboring surfaces, creating a flat surface. Furthermore, during this step, a micro-structured surface in terms of roughness can be created as well.

### BRIEF DESCRIPTION OF THE DRAWINGS

An embodiment of the invention will now be described with reference to the drawing, wherein:

FIG. 1 shows a schematic cross-sectional view of a water-hydraulic machine in the form of an axial piston machine,

FIG. 2 shows a front view of a control plate,

FIG. 3 shows a section A-A of FIG. 2,

FIG. 4 shows a section B-B of FIG. 2,

FIG. 5 shows a perspective view of the control plate,

FIG. 6 shows a schematic cross-sectional view of a water-hydraulic machine in the form of a pressure exchanger,

FIG. 7 shows a control plate and a detail of the surface of the control plate,

FIG. 8A-8E show cross sectional views during manufacturing of the control plate of a first embodiment,

FIG. 9A-9E show cross sectional views of the control plate in different stages of manufacturing a second embodiment,

FIG. 10A-10D show a micro-structured surface of a second polymer material provided in a section of the control plate,

FIG. 11A-11D show cross sectional views during a further approach for manufacturing a control plate, and

FIG. 12 shows a cross sectional view of a modification of the control plate, wherein the recessed portion accommodating the second polymer material has undercuts.

### DETAILED DESCRIPTION

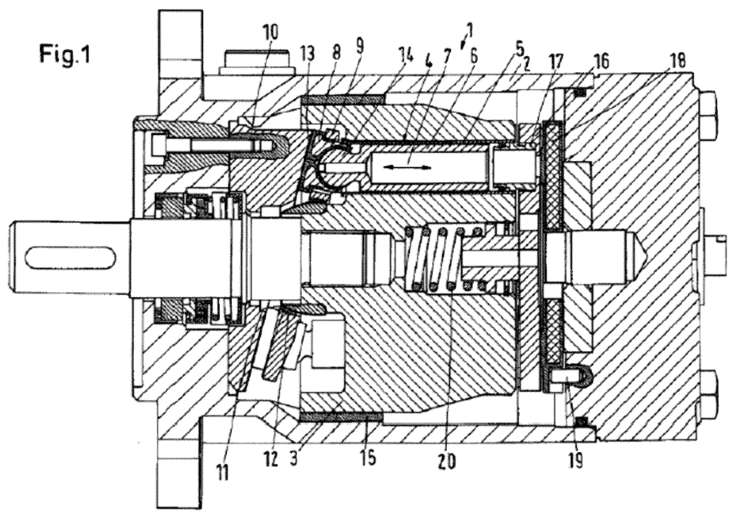

FIG. 1 shows a water-hydraulic machine 1 having a housing 2 in which a cylinder drum 3 is rotatably mounted.

At least one cylinder 4 is arranged in the cylinder drum 3. The cylinder 4 is provided with a sleeve 5. The sleeve 5 can be formed by a plastic material, for ex-ample in form of a polymer with a ceramic filler. A piston 6 is moveable in the cylinder 4 in the direction of a double arrow 7. Control of the movement of the piston 6 in cylinder 4 is carried out by a sliding shoe 8 which is held against a swash plate 10 under the action of a hold-down plate 9.

Hold-down plate 9 is supported via a ball joint having a ball 11 on the cylinder drum 3. For example, ball 11 can be made of duplex steel or super duplex steel. Hold-down plate 9 has an insert 12 composed of the above-mentioned polymer material having ceramic filler in the region of contact with ball 11. Other embodiments (not shown) have the retainer ball fixed to the retainer plate, and the bearing sits in a separate component.

Sliding shoe 8 is sleeved with a mold 13 from polymer with ceramic filler. Mold 13 is extended so far that it comprises a ball 14 at the front end of piston 6, wherein said ball 14 forms a part of a ball joint.

Cylinder drum 3 is mounted in housing 2 on a bearing surface 15 composed of polymer with ceramic filler, i.e. bearing surface 15 forms a radial bearing.

At the end facing away from the swash plate 10, a pressure plate 16 is provided into which sleeves 17 are inserted which themselves produce a connection between pressure plate 16 and cylinders 4. Pressure plate 16 bears against a control plate 18 which is arranged in a stationary manner in housing 2. It is held tight here by a pair of pins 19. Pressure plate rotates jointly with cylinder drum 3 with respect to control plate 18, so that control plate 18 can control the supply and discharge of hydraulic fluid to the cylinder 4 in the correct position.

Pressure plate 16 is pushed against control plate 18 under the force of a spring 20 and by an excess of hydraulic force arising from the pressure distribution on the pressure plate.

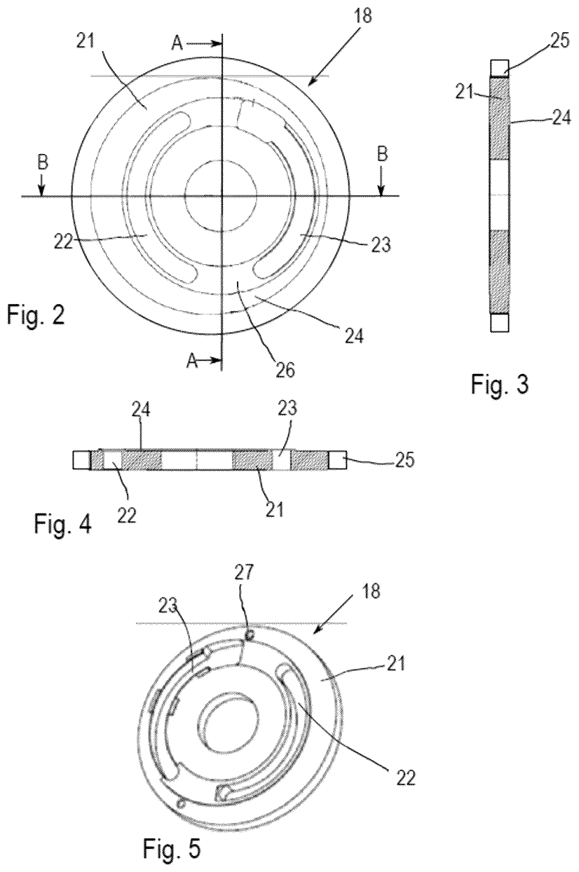

The control plate 18 (which can also be termed “port plate”) shown in FIG. 2 comprises a body 21, an arrangement of passage openings 22, 23, and a contact face 24. The contact face 24 is arranged on the side facing the pressure plate 16. The passage openings 22, 23 of the opening arrangement are kidney shaped.

The passage opening 22, 23 are configured for the passage of the hydraulic fluid in operation, especially for intermittent passage (flow) of the hydraulic fluid due to the passage openings being opened and closed by the counterpart, e.g. the pressure plate 16 of the hydraulic machine.

In other embodiments, the contact face 24 can bear directly against the cylinder drum 3. No pressure plate 16 is added in-between then.

The body 21 is made of a flat plastic material, in particular a first polymer material. The first polymer material comprises friction reducing properties, i.e. a friction between the control plate 18 and the pressure plate 16 is kept low even when water is used as a hydraulic fluid. A suitable plastic material is, for example, PEEK.

The first polymer material is a fiber reinforced plastic material having fibers of a length of at least 5 mm.

At least in a thickness region adjacent the contact face 24 more than 50% of the fibers include an angle with the contact face 24 of less than 30%. This can be achieved in a simple way in that the body 21 is built from a number of prepregs which are stacked above each other. A prepreg is a prefabricated material having a large number of fibers arranged in parallel and impregnated with a polymer material in an uncured state. When these prepregs are stacked above each other, a number of layers of fibers is produced, wherein the fibers in the layers are more or less parallel to each other and parallel to the contact face 24. The fibers in the layers can be orientated in different directions, however, basically in parallel to the contact face 24. Thus, the body 21 can be provided with a suitable strength and stiffness in all directions parallel to the contact face 24. In a direction perpendicular to the contact face 24 the body can be slightly compressible to form a spring, so that noise can be dampened.

When prepregs are used to produce the body 21, the polymer material can comprise a fiber content of at least 55%. The fibers are made of carbon, glass, or another filler material, like a ceramic filler.

The use of the prepregs has the advantage that the fiber orientation places as many fibers as possible parallel to the contact surface 24, so that tribological contacts can form on the side of the fibers and not at the ends.

There is a greater flexibility in terms of manufacturing. The use of fiber reinforced first polymer material (especially the combination of the high fiber content, the long fiber length, and the favorable fiber orientation) eliminates the need for using injection molding to overmold a steel insert to create the body 21. Hence, the final form of the body 21 is not tied to the geometries of injection molding tools or steel inserts. Additionally, since the body 21 no longer contains an over-molded steel insert, there is not necessity to ensure a uniform thickness of a layer of the plastic material in the kidney-shaped passage openings 22, 23.

The use of the prepregs has the further advantage that inclusion of air can be avoided. This will result in less dispersion in performance for control plates made of such a composite.

A steel ring 25 can be additionally disposed around the body 21 (not shown in FIG. 1). The steel ring guarantees a dimensional stability in the radial direction, i.e. when forces or pressures act on the control plate 18, the body can slightly be compressed, however, it cannot expand in the radial direction.

The contact face 24 comprises a sliding track 26 in which the contact face 24 can be smoother than outside the sliding track 26. The pressure plate 26 contacts the control plate 18 only in the region of the sliding track 26.

FIG. 5 shows the control plate 18 from the side opposite the contact face 24. A bore 27 for accommodating the positioning pins 19 can be seen.

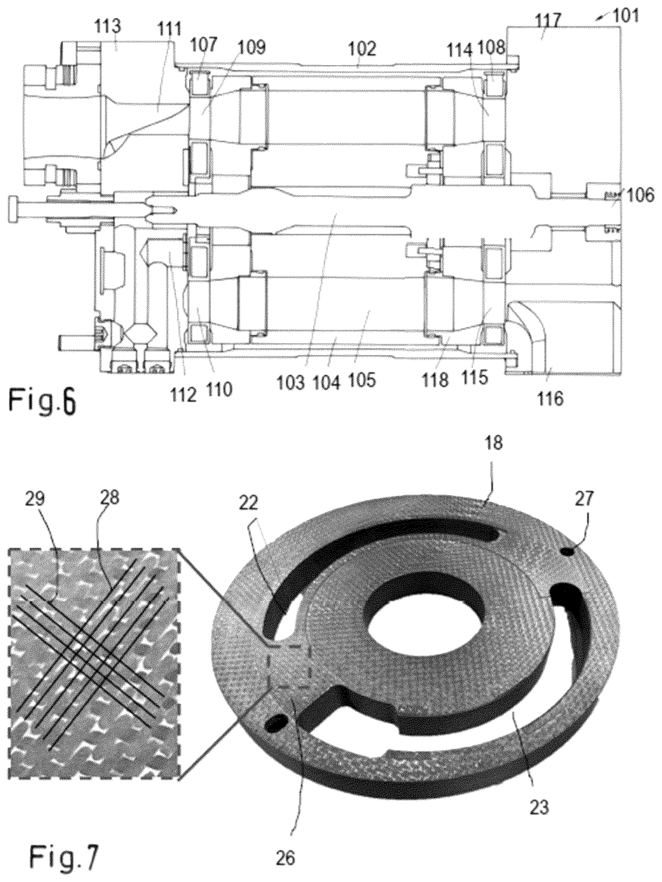

FIG. 6 shows schematically a hydraulic machine in form of a pressure exchanger 101 in which a control plate 18 as described above can be used for the same purpose.

The pressure exchanger 101 comprises a housing 102, a drive shaft 103 and a cylinder drum 104 which is rotatably arranged in the housing 102. The cylinder drum 104 comprises a plurality of cylinders 105 which are evenly distributed in circular (circumferential) direction around the drive shaft 103.

The cylinder drum 104 is rotationally fixed to the drive shaft 103. The drive shaft 103 comprises a driven end 106. The driven end 106 can be provided with a coupling to connect a drive motor or other driving means to rotate the drive shaft 103.

Control plates 107, 108 are arranged at each end of the cylinder drum 104. The cylinder drum 104 rotates with respect to the control plates 107, 108. The control plates 107, 108 can have the construction of the control plate 18 of the embodiment shown in FIGS. 2 to 5.

The first control plate 107 comprises two kidney-shaped passage openings 109, 110 which are connected to ports 111, 112 in an end part 113 of the housing 102. The second control plate 108 comprises two kidney-shaped passage openings 14, 15 which are connected to port 116 (the other port is not shown) in a second end part 117 of the housing 102.

A thrust plate 118 is arranged between the cylinder drum 104 and the second control plate 108. The thrust plate 118 is sealed with respect to the cylinders 105 of the cylinder drum 104 and is slightly moveable with respect to the cylinder drum 104, so that during operation it can be held in contact with the second control plate 108.

Even in this case, the control plates 107, 108 can be made without an insert of steel or other metal. The control plates 107, 108 are made of a flat polymer mate-rial.

FIG. 7 shows the control plate 18 in a perspective view. The same numeral as in FIGS. 1 to 5 are used.

FIG. 7 shows an enlarged view of the surface of the control plate 18 in the region of the sliding track 26. Schematically shown are fibers 28, 29 which are arranged substantially parallel to the surface of the control plate 18. The fibers 28 are arranged with an angle of approximately 90° with respect to the fibers 29. This can be realized by using a first prepreg comprising the fibers 28 and stacking another prepreg on the first prepreg, wherein the other prepreg comprises the fibers 29 and is arranged with the mentioned angular orientation with respect to the first prepreg.

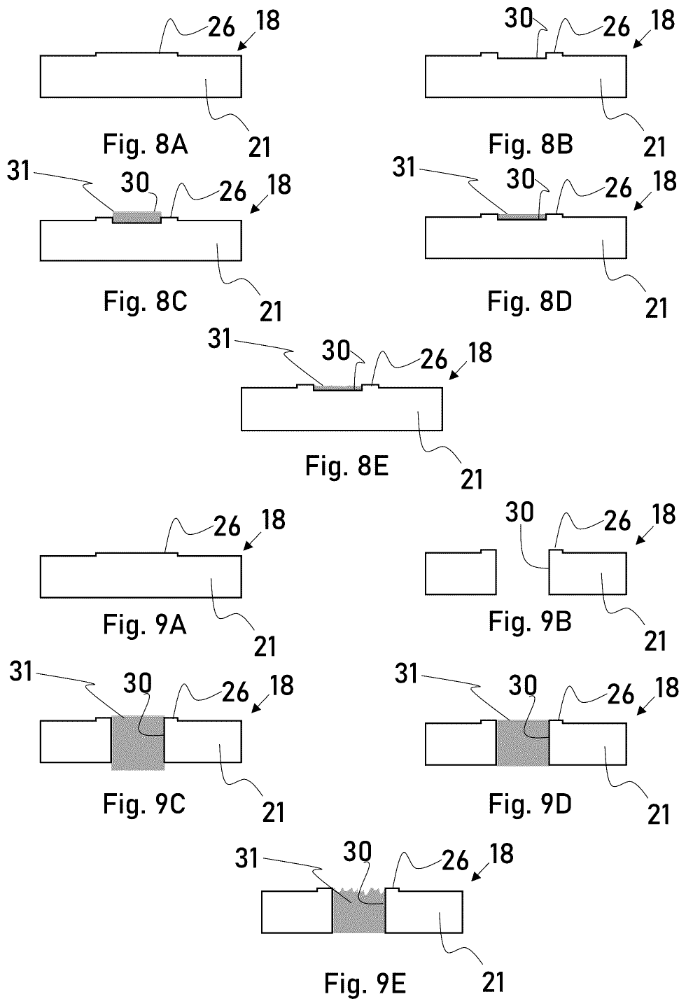

FIGS. 8A to 8E show different stages of manufacturing a control plate 18 in a partial cross-sectional view A-A according to a first embodiment.

FIG. 8A depicts a first step A, providing a body 21 of a control plate is provided having a circular sliding track 26. The body 21 is machined to comprise a recessed section 30, as depicted in FIG. 8B. The recessed section 30 is for example milled.

A second polymer material 31 is deposited in the recessed section. Depositing the second polymer material 31 can, for example include additive manufacturing.

During an additive manufacturing process, polymer material is deposited through a not depicted nozzle along a predetermined path in a layer. By depositing polymer material on top of a previous layer, a solid polymer part can be formed. This is repeated until a thickness of the second polymer is sufficiently strong. In the present invention, the second polymer material is deposited within the recessed section 30.

The recessed section 30 is recessed relatively to the adjacent surfaces by more than 0.1 mm but less than 3 mm, preferably less than 2 mm. The recessed section 30 is equipped with the second polymer material 31 to provide a cavitation with-standing section onto the body, as provided in FIG. 8C.

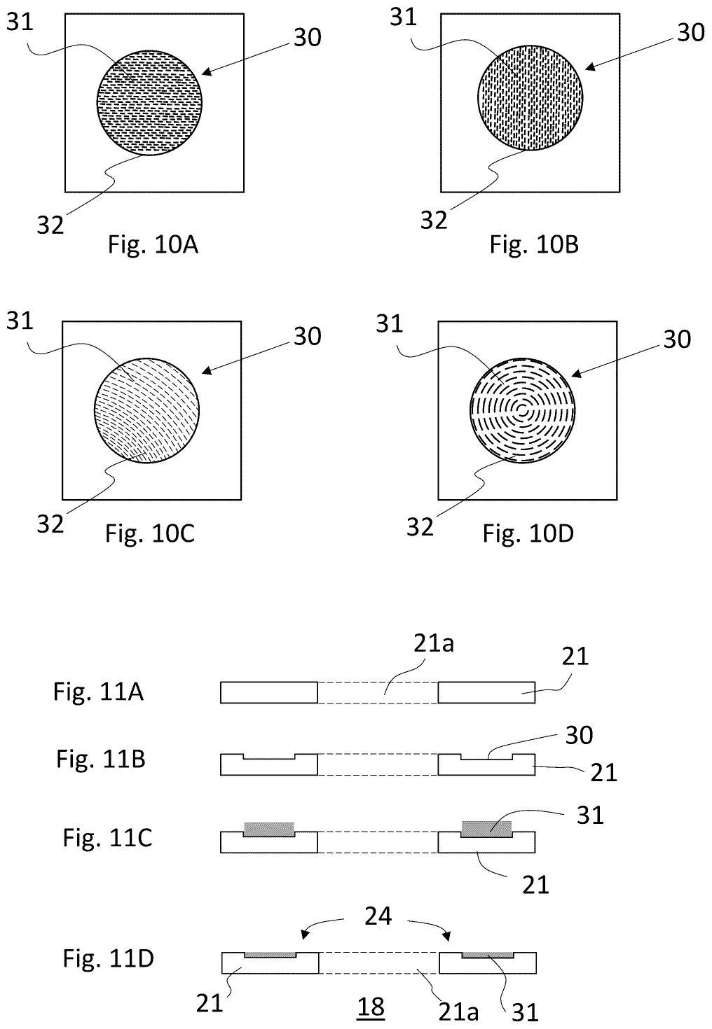

Depending on further production, the second polymer material 31 is applied by means of the additive manufacturing to form a flat surface in relation to adjacent surfaces of the recessed section 30. In this case, the additive manufacturing method can provide a micro-structured surface, as described later in combination with FIGS. 10A to 10C.

Alternatively, the second polymer material 31 is deposited to “overfill” the recessed section 30, such that the polymer material 31 protrudes relatively to the adjacent surfaces of the circular sliding track 26. In this case, a protruding portion of the second polymer material 31 is machined to create a flat surface in combination with the circular sliding track 26, as depicted in FIG. 8D.

In another alternative, the second polymer material 31 is provided as a solid element, which is fixed to the recessed section 30 by means of gluing, thermal bonding or alike. In this alternative, the second polymer material 31 might exceed the circular sliding track 26, such that the second polymer material 31 is machined to match the surface of the sliding track 26 forming a flat surface.

FIG. 8E shows a control plate 18 being equipped with a second polymer material 31 within a recessed section 30. The second polymer material 31 is worn as shown due to its irregular surface. The worn second polymer material 31 can be removed as described above with regard to FIG. 8B. To do so, the recessed section 30 is machined to its original shape, removing the deposited second material 31. Afterwards the recessed section 30 is equipped with new second polymer material 31 according to the subsequent steps of FIGS. 8A and 8B.

FIGS. 9A to 9E correspond to the FIGS. 8A to 8E, wherein the recessed section 31 penetrates through the body 21 in its thickness direction. A body 21 formed of a first polymer material is provided, as shown in FIG. 9A. Subsequently, the body 21 is provided with a through hole, the recessed section 30, as shown in FIG. 9B. The recessed section 30 is equipped with second polymer material 31 by means of additive manufacturing or by means of fixing an element formed of the second polymer material 31 into the recessed section 30.

In case of fixing the element formed of the second polymer material 31 into the recessed section, this element is formed accordingly to the form of the recessed section 30. The element is then bonded by means of gluing or thermal bonding to the body 21 formed of first polymer material. In order to have a flat surface, the element formed of second polymer material 31 is oversized, such that the second polymer material 31 exceeds the recessed section 30. The excess of the second polymer material 31 is removed by means of machining e.g., milling or alike.

In case of equipping the recessed section 30 by means of additive manufacturing, second polymer material 31 is deposited through a nozzle into the recessed section 30 bonding the second polymer material 31 to the body 21. One layer of second polymer material 31 is provided on top of a previously deposited layer of second polymer material 31 to fill the recessed section 30.

The second polymer material 31 can be deposited to exceed the recessed section 30. In this case the exceeding portion of the second polymer material 31 is machined to match neighboring surfaces of the sliding track 26.

Alternatively, the second polymer material 31 is deposited by means of additive manufacturing to match the surface of the sliding track 26. In this case, a micro-structured surface can be provided to the second polymer material 31 by means of additive manufacturing, as described in connection with FIGS. 10A to 10C.

As a result, the second polymer material 31 is flat in relation to adjacent surfaces, e.g. the sliding track 26.

FIG. 9E depicts a control plate 18 which comprises a section of second polymer material 31 provided in a recessed section 30. The second polymer material 31 is worn as indicated by its coarse surface. The worn second polymer material 31 can be removed according to FIG. 9B and refurbished with new second polymer material 31 according to steps of FIG. 9C and 9D. As a result, control plates 18 having a worn section of second polymer material 31 can be refurbished.

FIGS. 10A to 10D show an excerpt of a micro-structured surface of the second polymer material 31. The second polymer material 31 is provided in the recessed section 30 by means of additive manufacturing. The second polymer material 31 is squeezed through a nozzle, such that fibers 32 provided within the second polymer material 31 are oriented accordingly. By depositing the second polymer material 31 onto the base 21 or on previously deposited layers, the fibers 32 are deposited in this orientation. As the nozzle moves and deposits the second polymer material 31, the fibers orient themselves in a path of the nozzle, such that the fibers 32 in particular their orientation can be adjusted by defining the path of the nozzle accordingly.

FIG. 10A and FIG. 10B show a micro-structured surface, wherein the fibers 32 are oriented parallel to each other. In FIG. 10A, for example, the nozzle moves from left to right to deposit the second polymer material 31 and its fibers 32 accordingly.

Similar to FIG. 10A, FIG. 10B shows a parallel fiber 32 orientation, wherein the fibers are oriented top down. Accordingly, the nozzle moves from top to bottom depositing second polymer material 31.

FIG. 10C depicts a second polymer material 31, which is deposited such that the fibers are oriented in a circular arc following the curvature of the sliding track 26.

In FIG. 10D the fibers are oriented in a circular pattern. Other forms and orientations of the fibers are for example helical, diamond, rhombus pattern or alike. When selecting the shapes, attention should be paid to the existing conditions.

The orientation of the fibers 32 has an effect on the surface properties of the second polymer material 31 in particular on anti-cavitation characteristics.

FIGS. 11A to 11D show a further approach for manufacturing a control plate 18 according to the present invention. FIGS. 11A to 11D again show cross-sectional views at a location corresponding to A-A in FIG. 2 during manufacturing of the control plate 18.

In FIG. 11A, the initial body 21 for the control plate 18 is provided. The initial body 21 is completely formed of a first material, e.g. the first polymer material. Its basic shape is annular, like a disk with a central opening 21a. The central opening 21a is not a passage opening 22, 23.

Different from FIG. 8A, the initial body 21 does not include a circular sliding track (reference sign 26A in FIG. 8A). The sliding track could in this example be on the counterpart sliding against the control plate 18.

In a further step, the body 21 is machined to form the recessed section 30 (see FIG. 11B), similar as described above. It is noted that an additional step for roughening the surface of the body 21 in the recessed portion 30, e.g. by sand-blasting, could be performed.

Then, in a further step resulting in the state as shown in FIG. 11C, the second material is added. In this example, it is added at the recessed section 30 only. The second material can be a second polymer material 31 according to one of the modifications described above.

The second (polymer) material 31 can be added by means of additive manufacturing.

It is also possible to provide the second (polymer) material 31 as pre-manufactured part(s). In this case, the pre-manufactured second (polymer) material 31 is fixed to the body 21, for example by gluing.

According to one approach, the second (polymer) material 31 (or suitable pre-cursors) are added at the recess as powder and/or granules. By heating and smelting, the second (polymer) material 31 can be permanently fixed to the body 21.

It is possible that the second (polymer) material 31 protrudes too much out of the recessed portion 30 like shown in FIG. 11C. In this case, a further machining step may be performed in order to tear down at least a part of the protruding portion of the second (polymer) material 31. In FIG. 11D, the part of the second (polymer) material 31 forming part of the surface at the contact face 24 of the control plate 18 is even with the adjacent portions of the surface at the contact face 24 being formed by the body 21.

Naturally, the control plate 18 can be refurbished after exposure to cavitation erosion and/or other types of wear. For example, the steps shown on FIGS. 11B to 11D can be repeated. In this case, in the step leading to the state shown in FIG. 11B, the “old” second (polymer) material is removed.

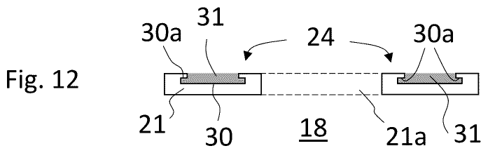

Optionally, the recessed section 30 can be machined to have one or more undercuts 30a. A modification of the control plate 18 in which the recessed portion 30 having undercuts 30a is shown in FIG. 12. The undercuts 30a lock the second polymer material 31 to the body 21. For example, the added second polymer material 31 can be melted into the undercut(s) 30a to form a mechanical locking mechanism, maybe in addition to a bond that should be formed by fusing the materials together.

While the present disclosure has been illustrated and described with respect to a particular embodiment thereof, it should be appreciated by those of ordinary skill in the art that various modifications to this disclosure may be made without departing from the spirit and scope of the present disclosure.

What is claimed is:

1. A control plate configured to equip a hydraulic machine for a hydraulic fluid, wherein the control plate comprises a body having an arrangement of passage openings for the passage of the hydraulic fluid and a contact face, wherein a whole thickness of the body is formed of a main material, wherein the main material is a first polymer material,
wherein the body comprises at least one distinct section which is made of a second polymer material, wherein the second polymer material is different from the main material.

2. The control plate according to claim 1, wherein characterized in that the at least one distinct section extends at least partially at a surface of the control plate.

3. The control plate according to claim 1, wherein the first polymer material is fiber reinforced polymer.

4. The control plate according to claim 1, wherein characterized in that the control plate comprises a circular sliding track at the contract face extending along a circular direction, wherein at least one of the passage openings is arranged in the sliding track, and wherein the second polymer material is arranged within the circular track.

5. The control plate according to claim 4, wherein the circular sliding track is raised in relation to surfaces adjacent to the circular sliding track.

6. The control plate according to claim 1, wherein the second polymer material is arranged at least between adjacent passage openings along a circumferential direction.

7. The control plate according to claim 1, wherein the second material is at least partially arranged in a recessed section of the body.

8. The control plate according to claim 7, wherein the recessed section has at least one undercut so that the second polymer material is mechanically locked to the body.

9. The control plate according to claim 1, wherein a thickness of the distinct section is more than 0.1 mm and less than 3 mm, preferably less than 2 mm, or the distinct section extends through the thickness of the control plate.

10. The control plate according to claim 1, wherein the second polymer material comprises a micro-structured surface.

11. The control plate according to claim 1, wherein the second polymer material is PEEK or PEEK comprising one or more filler material.

12. A hydraulic machine comprising a control plate according to claim 1.

13. A method to manufacture a control plate for a hydraulic machine, where-in the control plate comprises a body having an arrangement of kidney shaped openings and a contact face, wherein a whole thickness of the body is formed of a first polymer material, wherein the method comprises the following steps:
A) providing the body made of a first polymer material with an arrangement of passage openings and a contact face,
B) depositing a second polymer material within a section of the body, wherein the second material is different from the first material.

14. The method according to claim 13, wherein characterized in that after step A) and before step B), in step A1) a part of the body is removed to create a recessed section, wherein in step B) the second polymer material is deposited into the recessed section.

15. The method according to claim 14, wherein characterized in that in step A1) a worn section of the second polymer material is removed.

16. The method according to claim 13, wherein during step B) a micro-structured surface is created.
